(19) United States
(12) Patent Application Publication
(10) Pub. No.: US 2015/0286283 A1
(43) Pub. Date: Oct. 8, 2015

(54) METHOD, SYSTEM, MOBILE TERMINAL, AND STORAGE MEDIUM FOR PROCESSING SLIDING EVENT

(71) Applicant: TENCENT TECHNOLOGY (SHENZHEN) COMPANY LIMITED, Shenzhen (CN)

(72) Inventors: FEI CHENG, Shenzhen (CN); SHIZHU HUANG, Shenzhen (CN); WENJUN GAO, Shenzhen (CN); BO REN, Shenzhen (CN); YINSONG LIU, Shenzhen (CN)

(73) Assignee: TENCENT TECHNOLOGY (SHENZHEN) COMPANY LIMITED

(21) Appl. No.: 14/744,558

(22) Filed: Jun. 19, 2015

Related U.S. Application Data
(63) Continuation of application No. PCT/CN2013/084487, filed on Sep. 27, 2013.

(30) Foreign Application Priority Data
Dec. 24, 2012 (CN) 2012-10566419.4

(51) Int. Cl. G06F 3/01; G06F 3/041

(52) U.S. Cl. CPC G06F 3/017; G06F 3/041

(57) ABSTRACT

This application applies to the field of computer technologies, and provides a method and a system for processing a sliding event, and a mobile terminal. The method includes: first detecting a sliding event; then calculating the number of fingers involved in the sliding event; identifying the sliding event as a multi-finger sliding event if the number of the fingers involved in the sliding event is two or more; and if moving directions of all the fingers involved in the multi-finger sliding event are consistent, triggering an editing function for moving a picture. In such a manner, whether to move the picture is determined according to the number of the fingers involved in the sliding event and the moving directions of all the fingers, without the need of switching functional buttons, thereby making operations simple and convenient.

### CROSS-REFERENCES TO RELATED APPLICATIONS

This application is a continuation of PCT Application No. PCT/CN2013/084487, filed on Sep. 27, 2013, which claims priority to Chinese Patent Application No. CN 201210566419.4, filed on Dec. 24, 2012, the entire content of all of which is incorporated herein by reference.

### FIELD OF THE TECHNOLOGY

This application generally relates to the field of computer technologies, and, more particularly, to a method, system, mobile terminal, and storage medium for processing a sliding event.

### BACKGROUND OF THE DISCLOSURE

In existing handheld devices (for example, tablet computers and smart phones), there have been multiple types of picture editing software, which can perform operations such as cropping, image matting and the like on a picture. For example, the image matting is a fine operation, which needs a user to scale up the picture for the operation.

The screen size of the existing handheld devices is limited so that a center of the operation needs to be moved to the middle of the screen, which then involves picture moving. However, in the existing technology, it needs to frequently switch functional buttons for various functions such as brushing, moving and the like, leading to a complex operation and low efficiency.

### SUMMARY

One of the objectives of the present disclosure is to provide a method for processing a sliding event into an editing gesture, which may solve a problem in the existing technology that functional buttons need to be frequently switched during picture edition.

In an embodiment, the method may include the following steps:

detecting a sliding event, the sliding event being a touch event of pressing and then swiping with one or more fingers on a touch screen;

calculating the number of fingers involved in the sliding event, and identifying the sliding event as a multi-finger sliding event if the number of the fingers involved in the sliding event is two or more; and

determining whether moving directions of all the fingers involved in the multi-finger sliding event are consistent, and if the moving directions are consistent, triggering an editing function for moving a picture.

Another objective of the present invention is to provide a system for processing a sliding event into an editing gesture. The system may include:

a detecting unit, configured to detect a sliding event, the sliding event being a touch event of pressing and then swiping with one or more fingers on a touch screen;

a calculating and identifying unit, configured to calculate the number of fingers involved in the sliding event, and identify the sliding event as a multi-finger sliding event if the number of the fingers involved in the sliding event is two or more; and

a determining and triggering unit, configured to determine whether moving directions of all the fingers involved in the multi-finger sliding event are consistent, and if the moving directions are consistent, trigger an editing function for moving a picture.

Another objective of the present invention is to provide a mobile terminal, which includes a touch screen and the foregoing system for processing a sliding event into an editing gesture.

Another objective of the present invention is to provide a non-transitory computer readable storage medium including a computer readable program stored thereon. When being executed, the computer readable program causes a computing device to implement a method for processing a sliding event. The method includes:

detecting a sliding event, the sliding event being a touch event of pressing and then swiping with one or more fingers on a touch screen;

calculating the number of fingers involved in the sliding event, and identifying the sliding event as a multi-finger sliding event if the number of the fingers involved in the sliding event is two or more; and

determining whether moving directions of all the fingers involved in the multi-finger sliding event are consistent, and if the moving directions are consistent, triggering an editing function for moving a picture.

According to embodiments of the present disclosure, a sliding event is detected; the number of fingers involved in the sliding event is calculated; if the number of the fingers involved in the sliding event is two or more, the sliding event is identified as a multi-finger sliding event; and if moving directions of all the fingers in the multi-finger sliding event are consistent, an editing function for moving a picture is triggered. In such a manner, whether to move the picture is determined according to the number of the fingers involved in the sliding event and the moving directions of all the fingers, without the need of switching functional buttons, thereby making operations simple and convenient.

### BRIEF DESCRIPTION OF THE DRAWINGS

FIG. 1 illustrates a flowchart of a method for processing a sliding event according to an embodiment of the present invention;

FIG. 2 illustrates a schematic diagram of an example of a multi-finger sliding event according to an embodiment of the present invention;

FIG. 3 illustrates a schematic diagram of an example of a single-finger sliding event according to an embodiment of the present invention;

FIG. 4 illustrates a block diagram of a system for processing a sliding event according to an embodiment of the present invention; and

FIG. 5 illustrates an exemplary computing device consistent with the disclosed embodiments.

### DESCRIPTION OF EMBODIMENTS

To make the objectives, technical solutions and advantages of the present disclosure more comprehensible, the present disclosure is described in further detail below with reference to embodiments and the accompanying drawings. It should be understood that, the specific embodiments described herein are merely used for explaining the present disclosure, and are not intended to limit the present disclosure.

According to an embodiment of the present disclosure, a sliding event is detected; the number of fingers involved in the sliding event is calculated; if the number of the fingers involved in the sliding event is two or more, the sliding event is identified as a multi-finger sliding event; and if moving directions of all the fingers in the multi-finger sliding event are consistent, an editing function for moving a picture is triggered. In such a manner, whether to move the picture is determined according to the number of the fingers involved in the sliding event and the moving directions of all the fingers, without the need of switching functional buttons, thereby making operations simple and convenient.

The following describes the embodiments of the present invention in detail with reference to the accompanying drawings.

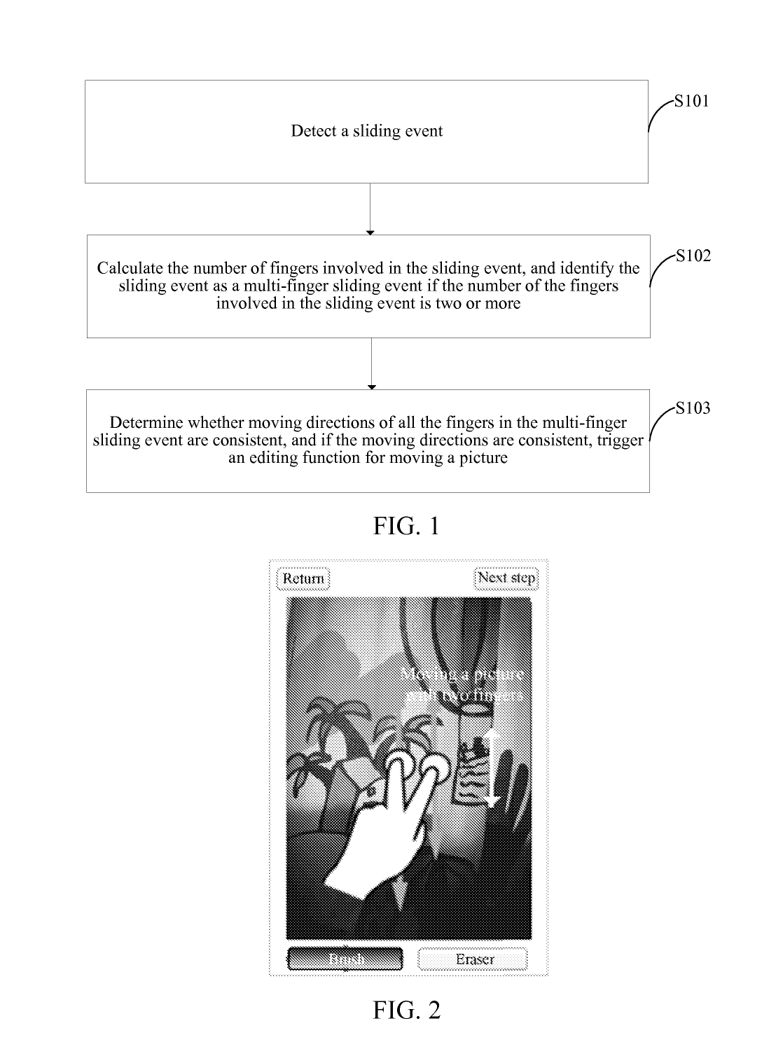

FIG. 1 shows an implementation flow of a method for processing a sliding event according to an embodiment of the present invention, which is described in detail as follows.

Step S101. Detecting a sliding (or swipe) event.

In one embodiment, a sliding event is detected with ScaleGestureDetector known in the art, where the sliding event is a touch event of pressing and then swiping with one or more fingers on a touch screen. For example, the ScaleGestureDetector may be a class android.view.ScaleGestureDetector, and this class is briefly described as follows:

According to a received MotionEvent, a distortion gesture triggered by multiple touch points (“multi-point touch control”) is detected. A callback function of an OnScaleGestureListener may be notified to a user when a specific gesture event occurs. The class can only be used in conjunction with a MotionEvent that is triggered by a touch control event. Using the class requires that:

(1) the ScaleGestureDetector is created and initialized for a view; and

(2) it is ensured that the class is invoked in a method of an onTouchEvent(MotionEvent) function, and a callback function defined by a user is executed when the event occurs.

Certainly, methods for detecting a sliding event re not limited thereto, and other detection methods known in the art may be adopted.

Step S102. Calculating the number of the fingers involved in the sliding event, and identifying the sliding event as a multi-finger sliding event if the number of the fingers involved in the sliding event is two or more (including 2).

In an embodiment, the number of the fingers involved in the sliding event is calculated according to a detection signal, for example, a signal sent by the ScaleGestureDetector. If the number of the fingers involved in the sliding event is two or more, the sliding event is identified as the multi-finger sliding event.

For example, if the number of the fingers involved in the sliding event is two, the multi-finger sliding event may be identified as a two-finger sliding event; if the number of the fingers involved in the sliding event is three, the sliding event may be identified as a three-finger sliding event; and if the number of the fingers involved in the sliding event is four, the sliding event may be identified as a four-finger sliding event. For example, the fingers involved in the two-finger sliding event may be an index finger and a middle finger, and may also be an index finger and a ring finger, or the like.

Step S103, Determining whether moving directions of all the fingers involved in the multi-finger sliding event are consistent, and if the moving directions are consistent, triggering an editing function for moving a picture.

In an embodiment, it is determined whether moving directions of all the fingers involved in the multi-finger sliding event are consistent, and if the moving directions are consistent, the multi-finger sliding event triggers an editing function for moving a picture.

FIG. 2 shows an example of triggering the editing function for moving a picture by a multi-finger sliding event. Although FIG. 2 shows that a two-finger sliding in a consistent movement direction triggers movement of the picture, the sliding event triggering the function for moving a picture is not limited to a two-finger operation, and may also be a three-finger, a four-finger, or even a five-finger operation.

In an embodiment, a moving distance of the picture can be determined by an offset distance between center points of the two fingers. For example, in the case of a sliding with an index finger and a middle finger, if the two fingers move in a consistent direction, the moving distance of the picture can be determined by the offset distance of the center points of the two fingers. In such a manner, whether to move the picture is determined according to the number of the fingers involved in the sliding event and the moving directions of all the fingers, without the need of switching functional buttons, thereby making operations simple and convenient.

Additionally, if the moving directions of both fingers in the two-finger sliding event are inconsistent, an editing function for scaling up a picture can be triggered by the two-finger sliding event.

If the number of the fingers involved in the sliding event is one, the sliding event can be identified as a single-finger sliding event, and can trigger an editing function for smearing a picture.

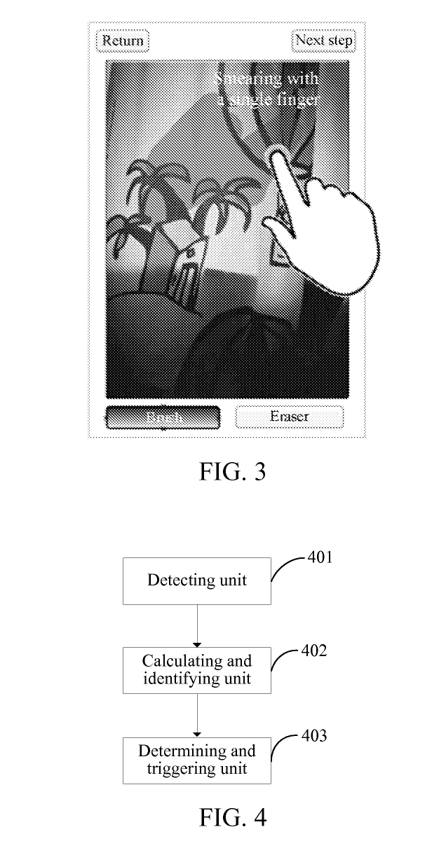

For example, FIG. 3 shows an example of triggering the editing function for smearing a picture by a single-finger sliding event, where a user can perform a smearing operation on the picture with a single finger on a touch screen. If it is required to move the picture, two or more fingers can be used to press against the picture and slide in a same direction so as to move the picture, as shown in FIG. 2. In such a case, it is not required to switch editing functional buttons for moving and smearing, thereby making operations simple and convenient.

In another embodiment, a single-finger sliding event can also trigger an editing function for cropping a picture, and the like. Similarly, when a user performs a single finger operation to implement a picture cropping function, a function for moving a picture may be triggered by a multi-finger sliding event in a same direction.

FIG. 4 is a block diagram of a system for processing a sliding event according to an embodiment of the present invention, which is described in detail as follows.

According to this embodiment, the system for processing a sliding event may include: a detecting unit 401, a calculating and identifying unit 402, and a determining and triggering unit 403. The detecting unit 401 may be configured to detect a sliding event, where the sliding event is a touch event of pressing and then swiping with one or more fingers on a touch screen. The calculating and identifying unit 402 may be configured to calculate the number of fingers involved in the sliding event, and identify the sliding event as a multi-finger sliding event if the number of the fingers involved in the sliding event is two or more. The determining and triggering unit 403 may be configured to determine whether moving directions of all the fingers involved in the multi-finger sliding event are consistent, and if the moving directions are consistent, trigger an editing function for moving a picture.

Optionally, the system may further include a determining unit (not shown in figure) which is configured to: if the number of the fingers involved in the sliding event is two, determine a moving distance of the picture by an offset distance between center points of the two fingers.

The determining and triggering unit may be further configured to, if the number of the fingers involved in the sliding event is two, and the moving directions of both fingers involved in the sliding event are inconsistent, trigger an editing function for scaling up a picture.

As an example, the foregoing system according to the present disclosure can be applied in a mobile terminal that has a touch screen display. Certainly, an application of the present disclosure is not limited thereto.

It should be noted that, specific operation principles of the foregoing units are described as above, and are not specifically described herein again. In addition, each unit of the foregoing system for processing a sliding event may be a software unit, a hardware unit, or a unit combining software and hardware, where the software unit part can be stored in a computer readable storage medium, such as a ROM/RAM, a magnetic disk, an optical disc, or the like.

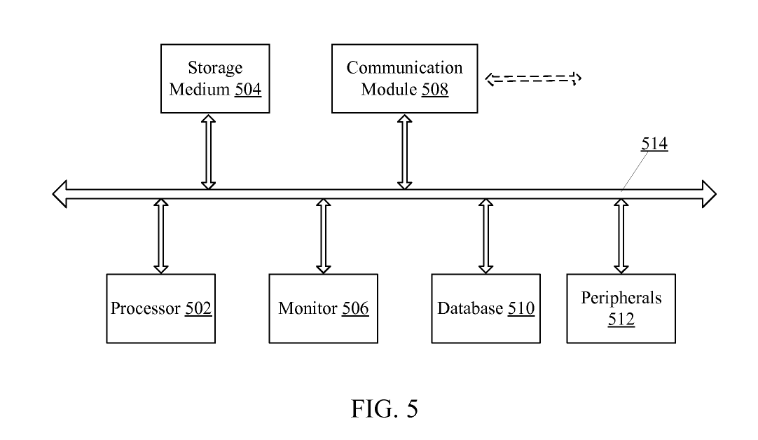

For example, FIG. 5 illustrates an exemplary computing device (e.g., including the mobile terminal) capable of implementing the disclosed methods, consistent with the disclosed embodiments. As shown in FIG. 5, the exemplary computing device 500 may include a processor 502, a storage medium 504, a monitor 506, a communication module 508, a database 510, peripherals 512, and one or more bus 514 to couple the devices together. Certain devices may be omitted and other devices may be included.

Processor 502 may include any appropriate processor or processors. Further, processor 502 may include multiple cores for multi-thread or parallel processing. The processor 502 may be used to run computer program(s) stored in the storage medium 504. Storage medium 504 may include memory modules, such as ROM, RAM, and flash memory modules, and mass storages, such as CD-ROM, U-disk, removable hard disk, etc. Storage medium 504 may store computer programs for implementing various disclosed processes, when executed by processor 502. In one embodiment, storage medium 504 may be a non-transient computer-readable storage medium having a computer program stored thereon, when being executed, to cause the computer to implement the disclosed methods.

Further, peripherals 512 may include I/O devices such as keyboard and mouse, and communication module 508 may include network devices for establishing connections, e.g., through a communication network such as the Internet. Database 510 may include one or more databases for storing certain data and for performing certain operations on the stored data, such as webpage browsing, database searching, etc.

In one embodiment, the computing device illustrated in FIG. 5 may include the disclosed system for processing a sliding event. For example, the system may include one or more processors and a non-transitory computer-readable storage medium having instructions/programs stored thereon, the instructions/programs executed by the one or more processors and including the modules and units disclosed in the system for processing a sliding event.

For example, the non-transitory computer readable storage medium may include a computer readable program stored thereon. When being executed, the computer readable program causes the computing device (e.g., a mobile terminal) to implement a method for processing a sliding event. In the method, a sliding event is detected. The sliding event is a touch event of pressing and then swiping with one or more fingers on a touch screen.

The number of fingers involved in the sliding event is calculated. The sliding event is identified as a multi-finger sliding event if the number of the fingers involved in the sliding event is two or more. It is determined whether moving directions of all the fingers involved in the multi-finger sliding event are consistent. If the moving directions are consistent, an editing function for moving a picture is triggered.

The above descriptions are merely preferred embodiments of the present invention, and are not intended to limit the present disclosure. Any modification, equivalent replacement and improvement made within the spirit and principle of the present disclosure shall fall within the protection scope of the application.

What is claimed is:

1. A method for processing a sliding event, comprising:
detecting a sliding event, the sliding event being a touch event of pressing and then swiping with one or more fingers on a touch screen;
calculating the number of fingers involved in the sliding event, and identifying the sliding event as a multi-finger sliding event if the number of the fingers involved in the sliding event is two or more; and
determining whether moving directions of all the fingers involved in the multi-finger sliding event are consistent, and if the moving directions are consistent, triggering an editing function for moving a picture.

2. The method according to claim 1, wherein, if the number of the fingers involved in the sliding event is two, a moving distance of the picture is determined by an offset distance between center points of the two fingers.

3. The method according to claim 1, wherein, if the number of the fingers involved in the sliding event is two, and the moving directions of both fingers involved in the sliding event are inconsistent, an editing function for scaling up a picture is triggered.

4. The method according to claim 1, wherein, if the number of the fingers involved in the sliding event is one, an editing function for smearing a picture is triggered.

5. The method according to claim 1, wherein, if the number of the fingers involved in the sliding event is one, an editing function for cropping a picture is triggered.

6. A system for processing a sliding event, comprising:
a detecting unit, configured to detect a sliding event, the sliding event being a touch event of pressing and then swiping with one or more fingers on a touch screen;
a calculating and identifying unit, configured to calculate the number of fingers involved in the sliding event, and to identify the sliding event as a multi-finger sliding event if the number of the fingers involved in the sliding event is two or more; and
a determining and triggering unit, configured to determine whether moving directions of all the fingers involved in the multi-finger sliding event are consistent, and if the moving directions are consistent, to trigger an editing function for moving a picture.

7. The system according to claim 6, wherein the system further comprises a determining unit, configured to: if the number of the fingers involved in the sliding event is two, determine a moving distance of the picture by an offset distance between center points of the two fingers.

8. The system according to claim 6, wherein, if the number of the fingers involved in the sliding event is two, and the moving directions of both fingers involved in the sliding event are inconsistent, the determining and trigging unit triggers an editing function for scaling up a picture.

9. A mobile terminal, comprising a touch screen and the system according to claim 6.

10. A non-transitory computer readable storage medium comprising a computer readable program stored thereon, wherein, when being executed, the computer readable program causes a computing device to implement a method for processing a sliding event, the method comprising:
detecting a sliding event, the sliding event being a touch event of pressing and then swiping with one or more fingers on a touch screen;
calculating the number of fingers involved in the sliding event, and identifying the sliding event as a multi-finger sliding event if the number of the fingers involved in the sliding event is two or more; and
determining whether moving directions of all the fingers involved in the multi-finger sliding event are consistent, and if the moving directions are consistent, triggering an editing function for moving a picture.

11. The method according to claim 10, wherein, if the number of the fingers involved in the sliding event is two, a moving distance of the picture is determined by an offset distance between center points of the two fingers.

12. The method according to claim 10, wherein, if the number of the fingers involved in the sliding event is two, and the moving directions of both fingers involved in the sliding event are inconsistent, an editing function for scaling up a picture is triggered.

13. The method according to claim 10, wherein, if the number of the fingers involved in the sliding event is one, an editing function for smearing a picture is triggered.

14. The method according to claim 10, wherein, if the number of the fingers involved in the sliding event is one, an editing function for cropping a picture is triggered.
